(19) United States
(12) Patent Application Publication
(10) Pub. No.: US 2011/0037989 A1
(43) Pub. Date: Feb. 17, 2011

(54) MEASUREMENT ARRANGEMENT WITH A MEASUREMENT HEAD IN ORDER TO CARRY OUT INSPECTION MEASUREMENT

(75) Inventor: Bo Pettersson, London (GB)

Correspondence Address: YOUNG & THOMPSON, 209 Madison Street, Suite 500, Alexandria, VA, 22314, US

(73) Assignee: HEXAGON METROLOGY AB, Nacka Strand (SE)

(21) Appl. No.: 12/867,324

(22) PCT Filed: Jan. 30, 2009
(86) PCT No.: PCT/SE09/50095

§ 371 Date: Oct. 27, 2010

(30) Foreign Application Priority Data
Feb. 14, 2008 (SE) 0800335-2

(51) Int. Cl. G01B 11/14

(52) U.S. Cl. 356/614

(57) ABSTRACT

A measurement arrangement with a measurement head (1) in order to carry out accurate measurements of objects that are to be subject to inspection measurement during, for example, a manufacturing process, whereby the measurement arrangement includes at least one mobile support and one measurement head (1) arranged at the end of the mobile support and including a measurement probe (2) that can be swivelled (B) and set at an angle (A) relative to the mobile support.

The present invention concerns a measurement arrangement with a measurement head in order to make accurate measurements of objects that are to be subject to inspection measurement during, for example, a manufacturing process.

There exists a need to be able to measure and monitor manufactured units accurately during a manufacturing process in order to determine whether these units satisfy the requirements posed for the manufacture or not. Measurement machines are available into which the manufactured units are placed, and the exact measurements and dimensions of the units can be determined with the aid of measurement heads that can be accurately displaced.

It is usual in manufacturing industry, such as the motor industry and the vehicle component industry, that industrial robots are used in order to handle and displace parts that are to be manufactured and parts that have been manufactured. It would be desirable that robots, and other mobile supports, could be used also in association with the inspection of manufactured units, such that it is not necessary to place the unit that are to be subject to inspection measurement into special measurement machines. The accuracy of the robots that are used is often too low to allow them to be used as measurement arrangements.

It is therefore one purpose of the present invention to achieve a measurement arrangement that can be used for accurate measurements, and that despite this can still be displaced easily to different measurement locations where the accurate measurement is to be carried out.

The above purpose of the invention is achieved with a measurement arrangement according to the invention, where the measurement arrangement comprises at least one mobile support and one measurement head arranged at the end of the mobile support and comprising a measurement probe that can be swivelled and placed at an angle relative to the mobile support.

According to one preferred embodiment of the invention, the measurement head, including the measurement probe, is arranged such that it can be displaced linearly relative to the attachment at the mobile support.

According to a further preferred embodiment of the invention, the mobile support is constituted by an industrial robot, whereby the measurement head is arranged at the end of its robot arm.

The mobile support may furthermore be constituted by an articulated arm, either a manual or a motor-driven arm. The range of motion of an articulated arm is constituted by swivel actions that are coupled with spacer elements, for example tubes of carbon fibre or aluminium.

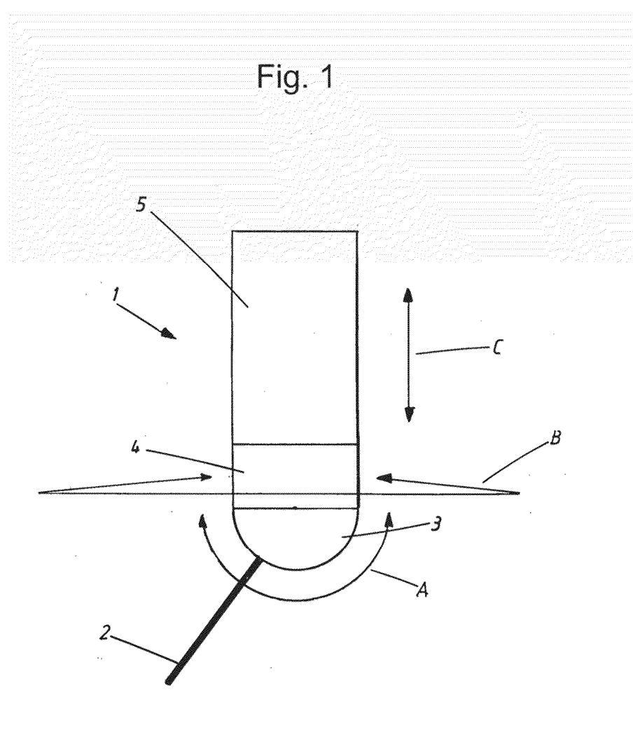

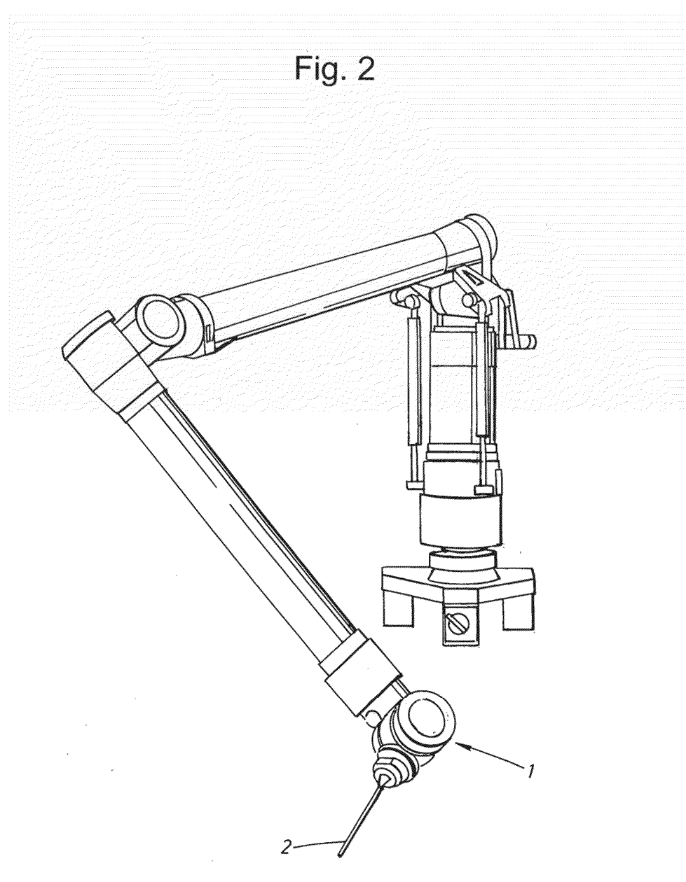

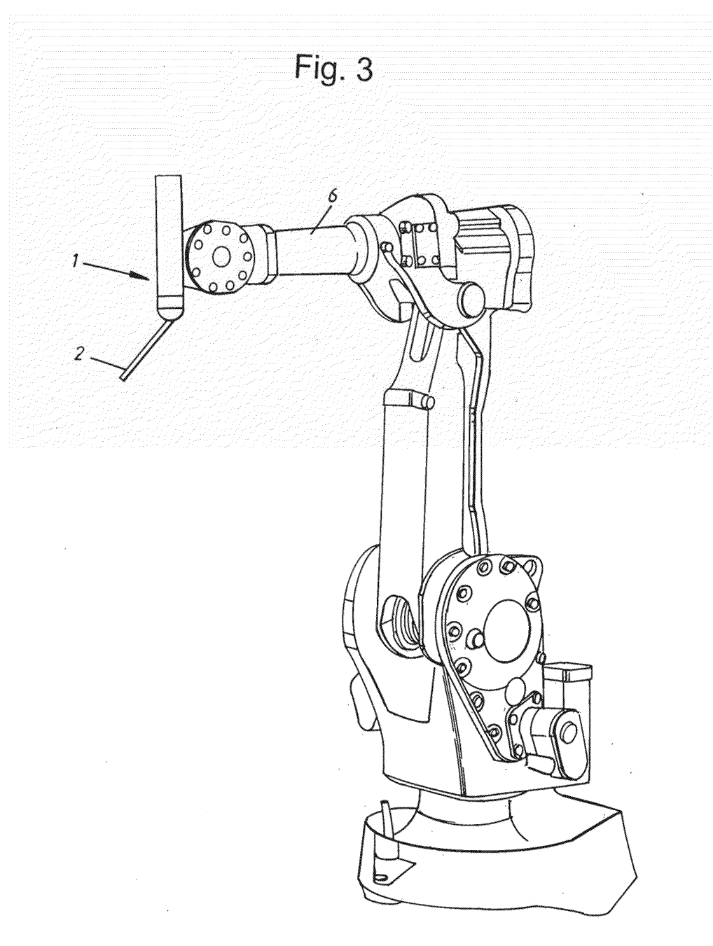

The invention will now be described in more detail in the form of a non-limiting embodiment of a measurement arrangement according to the invention, with the aid of the attached drawings, in which FIG. 1 shows a schematic drawing in principle of a measurement head for a measurement arrangement according to the invention and FIG. 2 and FIG. 3 show practical designs of a measurement head for a measurement arrangement according to the invention.

Thus, FIG. 1 shows a schematic drawing in principle for how a measurement head for a measurement arrangement according to the invention is constructed in order to function together with a mobile support, such as, for example, a robot arm.

The measurement head 1 according to FIG. 1 comprises a measurement probe 2, which may be of a contact type or a non-contact type, arranged at the outermost end of the measurement head 1, where the measurement probe 2 is attached at an end part 3 that can be swivelled. It can also be an integrated part of the unit 3 such that the measurement probe 2 may be swivelled forwards and backwards relative to the longitudinal axis of the measurement head, as shown by the arrow A. The end part 3 that may be swivelled is in turn attached to a rotary part 4 that can be rotated, this rotation being possible around the longitudinal axis of the measurement head 1 as shown by the arrow B. The rotary part 4 is attached at and may be rotated relative to the shaft part 5 of the measurement head, which extends along the longitudinal axis of the measurement head. It is preferable, but not necessary, that the shaft part 5 be designed in such a manner that it can be displaced linearly as shown by the arrow C relative to the point at which the measurement head is united with a support 6, see FIG. 3.

As has been mentioned in the introduction and as is shown in FIG. 2, the support may be an articulated arm 7, shown in the drawing as a manual articulated arm, that supports the measurement head 1 at the outermost end of the arm 7. The measurement head 1 can thus with the aid of this arm 7 be displaced to a selected initial location for a measurement, and it can then carry out the measurement without the arm itself being displaced. It is then only the parts of the measurement head 1 that move, i.e. the end part 3 and the rotary part 4 that are swivelled as shown by the arrows A and B, respectively, and this part may also be mobile in a linear manner relative to the arm 7 through the linear movement of the shaft part 5 as shown by the arrow C, in order to bring the measurement probe 2 into contact with the object that is to be measured. The displacement of the parts of the measurement head may be carried out and recorded very exactly, and this means that a very accurate and exact measurement of the displacements of the measurement probe 2 can be carried out.

A further design is one in which the support is an industrial robot, as is shown in FIG. 3, or a motor-driven articulated arm, that supports the measurement head 1 at the outermost end of the robot arm 6. Thus, the measurement head 1 can be displaced to a selected initial location for a measurement with the aid of this robot arm 6, and the measurement head can then carry out the measurement without the robot arm itself being displaced. It is then only the parts of the measurement head 3 that move, i.e. the end part 3 and the rotary part 4 that are swivelled as shown by the arrows A and B, respectively, and this part may also be mobile in a linear manner relative to the robot arm through the linear movement of the shaft part 5 as shown by the arrow C, in order to bring the measurement probe 2 into contact with the object that is to be measured. The displacement of the parts of the measurement head 1 may be carried out and recorded very exactly, and this means that a very accurate and exact measurement of the displacements of the measurement probe 2 can be carried out.

A high accuracy is obtained locally through such a measurement, within the working region of the measurement head+probe+linear movement, i.e. the unit according to FIG. 1. The accuracy of the support will influence the total accuracy, if it is necessary to displace the measurement unit. The local tolerance, however, is for many items greater than the “global” tolerance, i.e. it is possible to set high demands locally while the distance between the edges is lower. Such measurements may concern, for example, the inspection measurement of the dimensions of a cylinder in an engine block. In this case, the exact dimensions of the cylinder travel are of significantly greater interest than the distance between two cylinders in the engine block. Such a measurement of the exact dimensions of a cylinder can be carried out with the measurement head described above, which can be placed supported by a robot arm 6 in a suitable initial position above a cylinder in the engine block, and which then can carry cut a complete measurement of the dimensions of the cylinder solely by swivel of the end part 3 and the rotary part 4 together with linear displacement of the shaft part 5, without the need to displace further the robot arm 6.

In order to obtain also an accurate specification of position when it is necessary for the support to move during a measurement operation, it is possible to provide the measurement head or support, preferably the measurement head, with a laser tracker, indoor GPS, photogrammetric system or other 6-DOF technology. In this way, the possibility is available to be able to carry cut accurate measurements using a measurement arrangement according to the invention also of those dimensions for which it is necessary for the support to move during the measurement.

A robot arm normally has high repeat accuracy, and thus it has a good ability to repeat previously executed displacements. It is in this way possible for a normal repeated measurement to cause the robot arm to move to a pre-determined defined starting point for a measurement operation, and then to carry out the intended measurement based on this starting point. An industrial robot normally comprises a learned robot trajectory, which is inspected and adjusted by allowing the measurement arrangement to measure one or several known positions and then to calculate a new trajectory. It is in this way possible also to place a reference point to which the robot arm can be caused to move after, for example, a pre-determined number of measurement operations in order to check that the preset movement pattern of the robot is being followed, and if necessary, can be calibrated.

It is not necessary, as has been mentioned above, that the support be an industrial robot: it may also be a more conventional processing machine that is used for purposes of measurement.

1-9. (canceled)

10. A measurement arrangement with a measurement head (1) in order to carry out accurate measurements of objects that are to be subject to inspection measurement during, for example, a manufacturing process, wherein said measurement arrangement comprises at least one mobile support (6, 7), characterised in that the measurement head (1) is arranged at the end of the mobile support (6, 7) and comprising a measurement probe (2) that can be swivelled (B) and set at an angle (A) relative to the mobile support (6, 7), and that the measurement head (1) is arranged to conduct said measurements without displacement of the mobile support (6, 7).

11. The measurement arrangement according to claim 10, characterised in that the measurement head (1) is arranged such that it can be displaced linearly (C) relative to the mobile support (6, 7).

12. The measurement arrangement according to claim 10, characterised in that the mobile support (6) is constituted by an industrial robot.

13. The measurement arrangement according to claim 12, characterised in that the industrial robot comprises a learned robot trajectory, which is inspected and adjusted by allowing the measurement arrangement to measure one or several known positions and then to calculate a new trajectory.

14. The measurement arrangement according to claim 10, characterised in that the mobile support (7) is constituted by an articulated arm.

15. The measurement arrangement according to claim 12, characterised in that the measurement head (1) is arranged at the end of the support arm.

16. The measurement arrangement according to claim 10, characterised in that a laser tracker is arranged to determine the position of the measurement head (1).

17. The measurement arrangement according to claim 10, characterised in that a photogrammetric system is arranged to determine the position of the measurement head.

18. The measurement arrangement according to claim 10, characterised in that an indoor GPS is connected to the measurement head in order to receive signals from GPS transmitters arranged indoors in order to determine the position of the measurement head (1).

19. The measurement arrangement according to claim 11, characterised in that the mobile support (6) is constituted by an industrial robot.

20. The measurement arrangement according to claim 19, characterised in that the industrial robot comprises a learned robot trajectory, which is inspected and adjusted by allowing the measurement arrangement to measure one or several known positions and then to calculate a new trajectory.

21. The measurement arrangement according to claim 11, characterised in that the mobile support (7) is constituted by an articulated arm.

22. The measurement arrangement according to claim 14, characterised in that the measurement head (1) is arranged at the end of the support arm.
